(19) United States
(12) Patent Application Publication
(10) Pub. No.: US 2026/0113653 A1
(43) Pub. Date: Apr. 23, 2026

(54) RECOMMENDING IMPROVED COVERAGE SYSTEM

(71) Applicant: T-MOBILE INNOVATIONS LLC, Overland Park, KS (US)

(72) Inventor: Chaitanya CHUKKA, Carol Stream, IL (US)

(21) Appl. No.: 18/922,055

(22) Filed: Oct. 21, 2024

(51) Int. Cl. H04W 24/10; H04L 41/5009; H04W 16/18

(52) U.S. Cl. CPC H04W 24/10; H04L 41/5009; H04W 16/18

(57) ABSTRACT

Embodiments of the present disclosure are directed to systems and methods for generating recommendations to improve wireless network coverage within a geographic region. In order to accomplish this, a generative artificial intelligence (AI) is used to determine where the households requiring improved service are located and how residents of those households would use the improved service, and the generative AI may recommend the best way to effectively serve those households based on coverage options. A base station, via the generative AI, may determine the quality of coverage associated with a geographic region, and the aggregated coverage may be divided into clusters based on location data via K-means data clustering. Based on the anticipated return on investment in relation to the operational expenditure for increasing coverage for underserved households in the geographic regions, the generative AI may recommend a solution to increasing coverage for the underserved households.

### SUMMARY

The present disclosure is directed to for generating recommendations to improve wireless network coverage within a geographic region, substantially as shown and/or described in connection with at least one of the Figures, and as set forth more completely in the claims.

According to various aspects of the technology, an optimal location to build a cell tower and/or employ alternative means of increasing coverage in order to optimize return on investment (ROI) and customer lifetime value (CLV) in relation to the operational expenditure (OpEx) may be determined. In order to accomplish this, a generative artificial intelligence (AI) is used to determine where the households requiring improved service are located and how residents of those households would use the improved service, and the generative AI may recommend the best way to effectively serve those households based on coverage options. In some examples, an evolved node B (eNB) and/or a remote radio unit (RRU), via the generative AI, may analyze the aggregated coverage associated with a geographic region, then the aggregated coverage may be mapped to the United States census data. Here, a current customer base, underserved users, and unserved users, as well as areas with sporadic coverage, may be identified by the generative AI. In some aspects, the aggregated coverage (e.g., real time data) is divided into clusters based on location data (e.g., geographic location) via K-means data clustering. As such, after identifying which households are underserved (e.g., underserved may include experiencing underserved, unserved, and/or sporadic service), the households are clustered into a centroid by the K-means data clustering of the generative AI. Based on the anticipated ROI and CLV in relation to the OpEx for increasing coverage for the underserved households in each centroid, the generative AI may recommend the most efficient approach (e.g., solution) to increasing coverage for the underserved households, whether the approach is to build a new cell site or provide alternative means of coverage.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a network environment in which implementations of the present disclosure may be employed;

FIG. 3 illustrates determining a quality of coverage in which implementations of the present disclosure may be employed;

FIG. 4 illustrates generating a recommendation to increase the quality of coverage in which implementations of the present disclosure may be employed: and

FIG. 5 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz -3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the Broadband Equity, Access, and Deployment (BEAD) Program provides $42.45 billion in funds to expand high-speed internet access to all 50 states, Washington D.C., Puerto Rico, the U.S. Virgin Islands, Guam, American Samoa, and the Commonwealth of the Northern Mariana Islands. The BEAD Program funds projects that support infrastructure deployment, mapping, adoption, planning and capacity-building in state offices, and outreach and coordination with local communities. The BEAD Program funds partnerships between states or territories, communities, and stakeholders to build infrastructure where it's needed and to increase adoption of high-speed internet. This program establishes the state or territory's broadband goals and priorities and serves as a needs assessment to improve high-speed internet in the state and/or territory. This program was initiated by the National Telecommunications and Information Administration (NTIA) and states can effectively apply for this funding. The NTIA expects to provide technical assistance and feedback on the plans submitted by states and territories to improve their broadband coverage in underserved and/or unserved locations. The BEAD Program aims to provide internet for all, and consolidated coverage of all major operators is considered before identifying the locations which are underserved or unserved.

Conventionally, determining which locations are underserved or unserved is a manual process, which requires significant resources and time. For example, it took one wireless telecommunications carrier 3 months to survey the state of Michigan and determine 250 solutions of improving broadband coverage to underserved and unserved areas in the state. Furthermore, some solutions to poor broadband coverage are impractical. For example, the availability of a cell tower location, the remote distance of cell tower locations, and the return on investment (ROI) of building a new cell tower (e.g., cell site) may weigh against building a new cell tower to improve broadband coverage in underserved and unserved areas. For example, a plan to build a cell tower for 10 households with 3 people in each household (e.g., only 30 people would receive the new service from the new cell tower) may be impractical, because the costs of maintaining the tower in terms of operational expenditure (OpEx) and/or the overhead of the initial building stage, including the building efforts, may cost more than the ROI and/or the customer lifetime value (CLV). However, there may be other solutions besides building a new cell tower that could improve broadband coverage in geographic regions and that make financial sense in terms of OpEx, ROI, and CLV. As such, there is a need to optimize the process of determining how best to provide coverage for households (e.g., households may include domiciles, business buildings, construction sites, and any other type of structure and/or location where people reside, work, or regularly traverse) in underserved and unserved geographic regions without relying on inefficient uses of manual labor and resources.

Unlike conventional solutions, the present disclosure is directed to determining an optimal location to build a cell tower and/or employ alternative means of increasing coverage in order to optimize ROI and CLV in relation to the OpEx. In order to accomplish this, two steps should be taken: (1) determine where the households requiring improved service are located and how residents of those households would use the improved service, and (2) recommend the best way to effectively serve those households based on coverage options (e.g., direct or indirect coverage options). In some embodiments, a generative artificial intelligence (AI) is used to determine where and how to improve broadband coverage. In some examples, an evolved node B (eNB) and/or a remote radio unit (RRU), via the generative AI, may analyze the aggregated coverage associated with a geographic region, then the aggregated coverage may be mapped to the United States census data. Here, a current customer base, underserved users (e.g., the coverage is present but not strong enough to hold a data connection), and unserved users (e.g., there is no coverage at all), as well as areas with sporadic coverage (e.g., the radio frequency (RF) signal is either bouncing or sporadic), may be identified by the generative AI. In some aspects, the aggregated coverage (e.g., real time data) is divided into clusters based on location data (e.g., geographic location) via K-means data clustering. As such, after identifying which households are underserved (e.g., underserved may include experiencing underserved, unserved, and/or sporadic service), the households are clustered into a centroid by the K-means data clustering of the generative AI. Based on the anticipated ROI and CLV in relation to the OpEx for increasing coverage for the underserved households in each centroid, the generative AI may recommend the most efficient approach (e.g., solution) to increasing coverage for the underserved households, whether the approach is to build a new cell site or provide alternative means of coverage (e.g., installing a high power millimeter wave repeater, utilizing one or more satellites, utilizing a wireless backhaul with a standalone powered repeater, etc.). Accordingly, the present disclosure may satisfy the requirements laid down by the NTIA with the BEAD Program while simultaneously encouraging effective build costs.

Accordingly, a first aspect of the present disclosure is directed to method for managing the transmission of wireless signals in a wireless telecommunication network. The method comprises transmitting a first set of downlink signals using a first set of transmission characteristics to a geographic region. The method further comprises receiving, from each of a plurality of UEs communicatively coupled to a base station, a measurement report, each measurement report comprising one or more key performance indicators (KPIs) of the first set of downlink signals. The method further comprises aggregating the measurement reports to determine a portion of the geographic area having the one or more KPIs worse than a first predetermined threshold. The method further comprises determining a solution for a number of households located within the portion of the geographic region to exceed a second predetermined threshold. The method further comprises transmitting a second set of downlink signals based on the solution using a second set of transmission characteristics to the geographic region, wherein the one or more KPIs of the second set of downlink signals exceeds the first predetermined threshold in the portion of the geographic area.

A second aspect of the present disclosure is directed to a system for generating recommendations to improve wireless network coverage within a geographic region, the system comprising. The system comprises one or more computer processing components. The system further comprises a non-transitory computer readable media having instructions stored thereon that, when executed by the one or more computer processing components, cause the one or more computer processing components to perform operations comprising further comprises analyzing a quality of coverage of a geographic region based on aggregated data of relative service weakness stored in a database. The operations further comprise identifying a plurality of households located within a geographic region. The operations further comprise determining the plurality of households have underserved coverage. The operations further comprise generating a recommendation to increase the quality of coverage for the plurality of households, the recommendation comprising one or more coverage options.

Another aspect of the present disclosure is directed to a non-transitory computer readable media having instructions stored thereon that, when executed by one or more computer processing components, cause the one or more computer processing components to perform a method for generating recommendations to improve wireless network coverage within a geographic region. The method comprises analyzing a quality of coverage of a geographic region based on aggregated data of relative service weakness stored in a database. The method further comprises identifying a plurality of households located within the geographic region. The method further comprises determining the plurality of households have underserved coverage. The method further comprises generating a recommendation to increase the quality of coverage for the plurality of households, the recommendation comprising one or more coverage options.

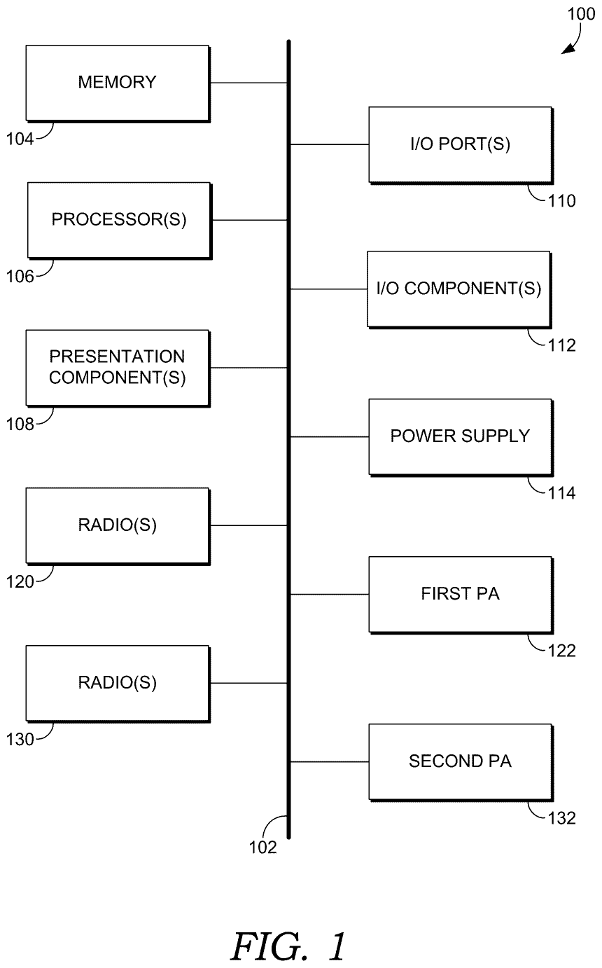

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

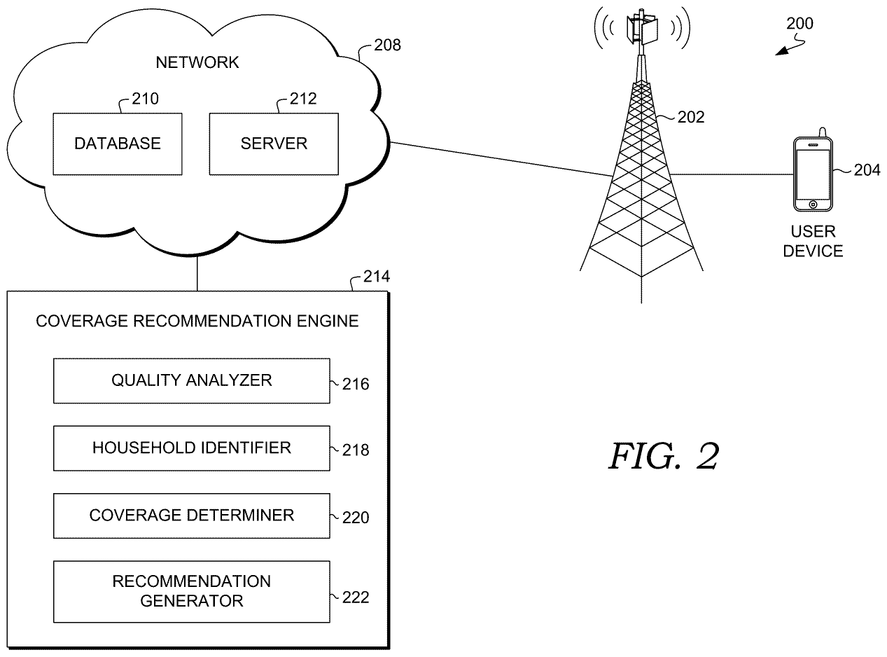

Turning now to FIG. 2, an exemplary network environment is illustrated in which implementations of the present disclosure may be employed. Such a network environment is illustrated and designated generally as network environment 200. At a high level, the network environment 200 comprises one or more UEs, one or more base stations, and one or more networks. Though a UE 204 is illustrated as a cellular phone, a UE suitable for implementations with the present disclosure may be any computing device having any one or more aspects described with respect to FIG. 1. Similarly, though a base station 202 is illustrated as a macro cell on a cell tower, any scale or form of access point acting as a transceiver station for wirelessly communicating with a UE, including small cells, micro cells, femtocells, pico cells, Wi-Fi access points (e.g., routers or mesh networks), distributed antenna systems, and the like, are suitable for use with the present disclosure.

In some embodiments, the base station 202 may be a station that communicates with the user devices 204 and a network 208. In some implementations, the base station 202 may be an eNB, a next generation eNB (gNB), an access point, or one or more combinations thereof. The base station 202 may provide communication coverage for a geographic region (e.g., a particular geographical coverage area). In embodiments, the base station 202 may provide communication services via one or more frequency bands in licensed spectrum, unlicensed spectrum, the like, or one or more combinations thereof. In addition, in some examples, the base station may operate in an extremely high frequency region of the spectrum (e.g., from 30 GHz to 300 GHz), also known as the millimeter band.

The network environment 200 comprises one or more base stations with which a UE may wirelessly communicate. In some aspects, the UE 204 may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band. As used herein, the term “base station” (e.g., used for providing UEs with access to the telecommunication services) or “node” generally refers to one or more base stations, nodes, RRUs control components, and the like (e.g., configured to provide a wireless interface between a wired network and a wirelessly connected user device). For example, the base station 202 may refer to a base transceiver station, a radio base station, an access point, a radio transceiver, a NodeB, an eNB, a gNB, a Home NodeB, a Home eNodeB, another type base station, or one or more combinations thereof.

The base station 202 comprises hardware and software components that allow it to wirelessly communicate with one or more UEs in one or more coverage areas. As such, the base station may be communicatively coupled to the one or more UEs in one or more coverage areas. Each coverage area may be logically defined in space and frequency as one or more cells, which may or may not overlap. Using any radio access technology selected by a mobile network operator (e.g., 4G, 5G, 6G, 802.11x, and the like), the base station may transmit and receive wireless signals using one or more antenna elements. For example, the base station 202 may transmit different sets of downlink signals (e.g., such as a first set of downlink signals and a second set of downlink signals) using different transmission characteristics to the coverage area (e.g., a geographic region). In some aspects, the base station 202 may be configured as FD-MIMO, massive MIMO, MU-MIMO, cooperative MIMO, 3G, 4G, 5G, another generation communication system, or one or more combinations thereof.

Each base station of the one or more base stations may be associated with one or more at least partially distinct networks, such as the network 208, wherein each network is associated with one or more network identifiers. Each network, may be a telecommunications network(s) (e.g., a packet data network or core network), data network, or portions thereof. In some examples, the network 208 may comprise a server 212 to manage network performance. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations. For example, components of the network 208 may include core network nodes, relay devices, integrated access and backhaul nodes, macro eNBs, small cell eNBs, gNBs, relay base stations, other network components, or one or more combinations thereof. The network 208 may interface with one or more base stations through one or more wired or wireless backhauls. As such, the one or more base stations may comprise one or more nodes (e.g., eNB, gNB, and the like) that are configured to directly communicate with user devices, or the one or more base stations may communicate to devices via the network 208. Furthermore, user devices can utilize the network 208 to communicate with other devices (e.g., a user device(s), a server(s), internet of things devices, etc.) through the one or more base stations. In some aspects, the one or more base stations may include one or more band pass filters, radios, antenna arrays, power amplifiers, transmitters/receivers, digital signal processors, control electronics, GPS equipment, and the like.

In some examples, the network 208 may comprise a database 210. In some embodiments, the database 210 is a standalone database that is used by a coverage recommendation engine 214 to generate recommendations to improve wireless network coverage within a geographic region. In some aspects, the database 210 may be a database that is shared with other systems to accomplish more tasks within the scope of this disclosure and/or outside the scope of this disclosure. In some embodiments, users may store data associated with the quality of coverage of a certain geographic region in the database 210. In some examples, the quality of coverage may include the signal strength, bandwidth capacities, latency, connectivity effectiveness, interference events, and drop rates associated with a geographic region. In some embodiments, the quality of coverage is synonymous with a measurement report (e.g., a measurement of the quality of coverage in a geographic region).

In order to generate recommendations to improve wireless network coverage within a geographic region (e.g., manage the transmission of wireless signals in a wireless telecommunications network), the network environment comprises the coverage recommendation engine 214. Though illustrated as a dedicated engine comprising four discrete modules, the coverage recommendation engine 214 and its modules are described herein by way of their functionality and may be deployed or implemented in various ways that are consistent with the functionality described herein. For example, the coverage recommendation engine 214 may take the form of one or more computer processing components at or near the base station 202 executing computer executable instructions that cause the one or more computer processing components to perform the operations described herein. The coverage recommendation engine 214 may be said to comprise a quality analyzer 216, a household identifier 218, a coverage determiner 220, and a recommendation generator 222.

The quality analyzer 216 is configured to analyze a quality of coverage of a geographic region based on data stored in a database, such as the database 210. In some embodiments, the quality analyzer 216 receives a measurement report from the database 210, and the measurement report includes key performance indicators (KPIs) (e.g., an aggregation of the measurement reports) associated with the quality of coverage of a geographic region (e.g., associated with a first set of downlink signals). In some aspects, the quality analyzer 216 is a generative AI. Relevant to the present disclosure, the quality analyzer 216 may analyze aggregated input data associated with a quality of coverage for a specific geographic region.

The household identifier 218 is configured to identify a number of household located within a specific region. In some aspects, the household identifier 218 is a generative AI. In some embodiments, the household identifier 218 may aggregate input data associated with households located within a specific geographic region to identify a number of households within that geographic region. In some embodiments, the household identifier 218 aggregates a number of measurement reports associated with households in a portion of the specific geographic region.

The coverage determiner 220 is configured to determine a number of households that have underserved coverage. In some examples, the coverage determiner 220 is a generative AI. In some aspects, the coverage determiner 220 may map the aggregated coverage analyzed by the quality analyzer 216 to the number of households in a specific geographic region identified by the household identifier 218 to determine the number of households within a geographic region that have underserved coverage. In some embodiments, the coverage determiner 220 maps the aggregated measurement reports to determine which households in a portion of the specific geographic region have a KPI worse than a first predetermined threshold.

The recommendation generator 222 is configured to generate a recommendation to increase the quality of coverage for the number of households within a geographic region that have underserved coverage. In some aspects, the recommendation generator 222 is a generative AI. In some embodiments, the recommendation generator 222 may filter through coverage options that would increase the quality of coverage for households within a geographic coverage region based on the ROI, CLV, and OpEx associated with each coverage option, and the recommendation generator 222 may recommend a coverage option (e.g., a solution) to increase the quality of coverage while optimizing the ROI and CLV in relation to the OpEx associated with implementing the coverage option. In some embodiments, the recommendation generator 222 may determine a solution for households located within a portion of a geographic region, such as a solution that results in KPIs that exceeds a second predetermined. For example, the recommendation generator 222 may recommend a solution that includes transmitting a set of downlink signals using a set of transmission characteristics to the geographic region, and the KPIs of the set of downlink signals may exceed the first predetermined threshold.

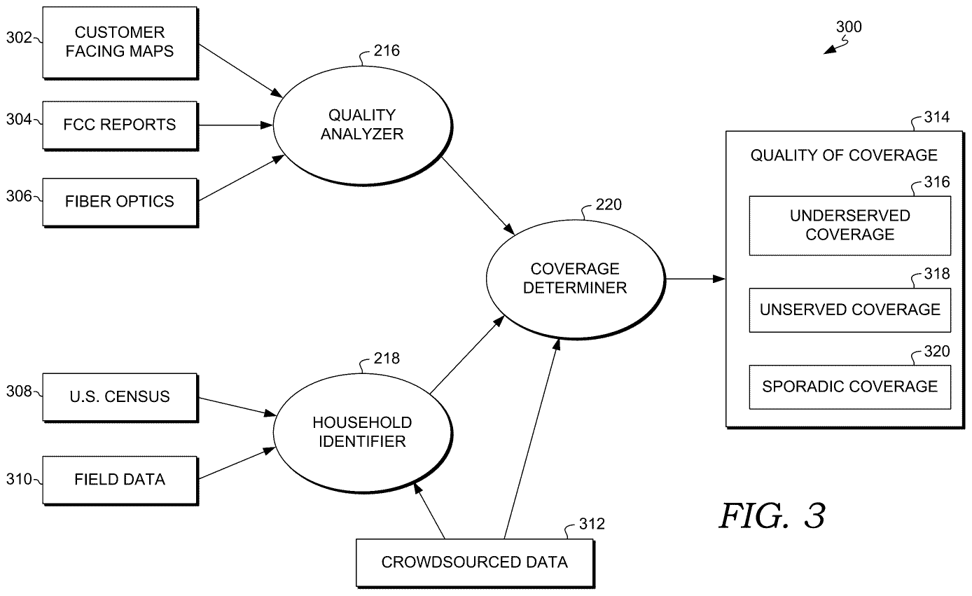

Turning now to FIG. 3, an example of a determined quality of coverage 300 is provided. The determined quality of coverage visually illustrates components of the coverage recommendation engine 214 determining that a certain number of households within a geographic region have underserved coverage. As can be seen in the example illustrated in FIG. 3, the quality analyzer 216, the household identifier 218, and the coverage determiner 220 of the coverage recommendation engine 214 receive inputs to determine a quality of coverage 314 for a certain number of households within a geographic region. In some examples, the inputs used by these components of the coverage recommendation engine 214 (e.g., the quality analyzer 216, the household identifier 218, and the coverage determiner 220) are stored in the database 210.

In some aspects, the quality analyzer 216 utilizes the aggregated input data of customer facing maps 302, Federal Communication Commission (FCC) reports 304, and fiber optics 306, among other inputs, to analyze a quality of coverage of a geographic region. For example, the customer facing maps 302 includes data that is associated with the coverage areas of the major telecommunication carriers (e.g., where the coverage areas are and the signal strengths of the coverage areas). In some embodiments, the major telecommunication carriers may use orthogonal frequency division multiplexing to enhance the efficiency of one or more signals (e.g., increase the quality of coverage), and this information may be stored in a database and used by the quality analyzer 216. In some examples, although it may be difficult to determine the coverage areas of all of the major telecommunication carriers (e.g., because that information is not published in much detail), a first telecommunication carrier may use the perspective of their own coverage based on their own cell towers (e.g., the signal strength), as well as based on their experience of coverage strength while operating on other telecommunication carriers' cell towers (e.g., where telecommunication carriers' cell towers are located is publically accessible information), to approximate the coverage provided by the other telecommunication carriers in certain coverage areas (e.g., specific geographic regions). In some embodiments, this data (e.g., the coverage of a first telecommunication carrier and the coverage of the other telecommunication carriers) may be stored in the database 210 and used by the quality analyzer 216 to analyze a quality of coverage of a geographic region. In some examples, the quality analyzer 216 may use the customer facing maps 302 to approximate the coverage of a first telecommunication carrier as well as the coverage of the other telecommunications carriers (e.g., the coverage of competitors of the first telecommunication carrier).

In some examples, the quality analyzer 216 may use measurement reports associated with one or more KPIs of a set of downlink signals related to the UEs communicatively coupled to a base station of the telecommunications network. For example, these KPIs may include latency, throughout, packet loss rate, jitter, drop call rate, quality of experience (QoE) (e.g., user satisfaction metrics based on feedback surveys), network availability/uptime, signal strength/quality, device connection time, error rates (e.g., the frequency of errors encountered during data transmission), usage patterns, and other KPIs associated with developing a measurement report of the downlink signals related to a base station. Accordingly, a base station may transmit a set of downlink signals using a set of transmission characteristics to a geographic region, and a measurement report may be generated (e.g., and stored, such as in the database 210) that includes KPIs associated with the set of downlink signals. These measurement reports may be used by the quality analyzer 216 to analyze a quality of coverage of a geographic region. For example, the measurement reports may be aggregated by the quality analyzer 216 (or may be stored in the database 210 in an aggregated format) and used by the quality analyzer 216 to analyze (e.g., and in some embodiments, determine) a quality of coverage for a portion of a geographic area that has KPIs worse than a predetermined threshold (e.g., a threshold indicating that a telecommunications company should increase the quality of coverage in that portion of a geographic region, such as for BEAD purposes).

In some aspects, the spectrum bands associated with all of the telecommunication carriers is publicly known knowledge. In some embodiments, the FCC publishes the latest updates of the broadband coverage provided by the major telecommunication carriers, and these FCC reports 304 may be used as input data for the quality analyzer 216. However, there is often a one-month delay in the coverage that is published by the FCC in the FCC reports 304. As such, in some examples, the quality analyzer 216 may approximate the quality of coverage of a geographic region in real-time or near real-time (e.g., based on historical increases and/or decreases associated with broadband coverage related to, for example, the creation and/or destruction of new cell sites). For example, if a new cell site recently went active (e.g., within the last month), the new cell site would likely affect the quality of coverage in an area. Accordingly, the FCC reports 304 may be used as a threshold baseline that the quality analyzer 216 may use to approximate the actual coverage of a geographic region as it is today (e.g., based on recent upgrades that increased coverage and/or events that decreased coverage in a specific region).

In some examples, information related to the fiber optics 306 from fiber optic companies (e.g., such as cable companies) may be used as input to the quality analyzer 216. For example, the fiber optics 306 may include information regarding which households are being serviced by fiber optic companies (e.g., where people have access to the internet). In some aspects, the fiber optics 306 information may be useful, because the essence of BEAD is to enhance internet capabilities as well as voice connectivity (e.g., connection to telecommunications networks). In some examples, an area may not have service because there are no fiber optic cables that run in that area, and that information is useful for the quality analyzer 216 in analyzing the quality of coverage for a geographic region.

In some aspects, the household identifier 218 utilizes the aggregated input data of U.S. census 308, field data 310, and crowdsourced data 312, among other inputs (e.g., such as the measurement reports), to identify a number of households located within a specific region and how residents of those households would use improved services (e.g., increases in broadband coverage). In some examples, the U.S. census 308 includes key population statistics about specific geographic regions across the United States. In some embodiments, the U.S. census 308 may include data associated with the U.S. census itself (e.g., the decennial census of population and housing), the American community survey (ACS), the American housing survey (AHS), current population survey (CPS), housing vacancy survey (HVS), and any other demographic, economic, and/or sponsored surveys conducted by the U.S. Census Bureau. As such, the U.S. census 308 is an input that includes data associated with the population and number of households within geographic regions. In some examples, data associated with the U.S. census 308 is regularly updated and stored in the database 210 for the household identifier 218 to utilize in identifying a number of households located within a specific region. In some embodiments, data associated with the U.S. census 308 may not be up to date. However, in some examples, the household identifier 218 may approximate the number of households located within a specific region in real-time or near real-time. For example, based on historic trends of population fluctuations associated with the U.S. census 308 (e.g., such as the construction or deconstruction of new housing complexes, for example), the household determiner may use the U.S. census 308 to approximate the actual number of households located within a specific region as it is today.

In some aspects, the field data 310 may include data associated with how the people located within the households located within a specific geographic region are expected to use an increased quality of coverage (e.g., better service). For example, the field data 310 may include information regarding the number of students within a certain geographic region (e.g., who may require greater broadband to meet academic demands), information regarding the number of businesses located within the geographic region (e.g., businesses may require increased coverage based on the needs of the business; for example, hospitals may demand a higher quality of coverage), and any other information regarding how the customers (e.g., a current customer base and/or potential customers) may use an increase in the quality of coverage. As such, in some examples, the field data 310 may include an increase in a quality of coverage that people located within a specific geographic region are expecting to receive with the implementation of a BEAD solution. In some examples, the field data 310 may be obtained by field workers (e.g., salespeople, for example) and uploaded to the database 210.

In some embodiments, the household identifier 218 may process the crowdsourced data 312 in determining the number of households located within a geographic region. For example, the crowdsourced data 312 may include user base data, such as where users are using their phones. In some examples, the data that users use on their UEs (e.g., crowdsourced data) is often geographically recorded (e.g., where the user used their UE) within 30 meters of use, and this crowdsourced data 312 often includes the condition of the signal strength in the geographic region, the quality of service (QoS) that the user is trying to use in the geographic region, and other customer proprietary network information (CPNI) (e.g., the data collected by telecommunications companies about their customers'usage of network services, including, but not limited to, call records, billing information, service usage, etc.). In some embodiments, because crowdsourced data 312 may be CPNI, the crowdsourced data 312 may be highly sensitive information. As such, the identity of the users associated with the crowdsourced data 312 are generally not stored (e.g., in the database 210), but rather any crowdsourced data 312 that may be considered CPNI may be stored in hexagonal bins as a data visualization technique. In some examples, the crowdsourced data 312 may be shared with third party users. In some aspects, a user may open an application on their UE (e.g., cellphone, tablet, etc.) and the application may transmit the crowdsourced data 312 back to the cloud and that data may be stored in a database for use by the household identifier 218 (e.g., and/or the coverage determiner 220).

In some examples, the coverage determiner 220 may use the crowdsourced data 312 to determine the quality of coverage 314 in a specific geographic area. In some aspects, the quality of coverage 314 may be considered underserved coverage 316 (e.g., the coverage is present but not strong enough to hold a data connection), unserved coverage 318 (e.g., there is no coverage at all), or sporadic coverage 320 (e.g., the radio frequency (RF) signal is either bouncing or sporadic). In some examples, if the quality of coverage 314 for a specific geographic region is determined to not be considered underserved coverage 316, unserved coverage 318, nor sporadic coverage 320, then the quality of coverage 314 for that specific geographic region likely meets the coverage threshold that the BEAD program aims to achieve. In some embodiments, the underserved coverage 316, the unserved coverage 318, and the sporadic coverage 320 may all be considered underserved coverage.

In some aspects, the coverage determiner 220 may map the aggregated coverage analyzed by the quality analyzer 216 to the number of households in a specific geographic region identified by the household identifier 218 to determine the number of households within a geographic region that have underserved coverage 316, unserved coverage 318, or sporadic coverage 320. In some embodiments, the coverage determiner 220 may determine the number of houses located within a specific region and a precise coverage (e.g., the coverage is the summation of all the wireless companies that are currently in service) associated with those houses. In some examples, the coverage determiner 220 may combine the data associated with the households and the precise coverage to identify mobile dead zones (e.g., unserved coverage 318), which means that at a specific geographic region (e.g., a certain amount of square meters of an area) there is no coverage from any telecommunications carrier at all. In some aspects, the coverage determiner 220 may determine the dead zones of a specific geographic region, and the coverage determiner 220 may compare data associated with the dead zones with the crowdsourced data 312 to determine the location of the households and the number of users associated with each household in the dead zone (e.g., the number of households and users with unserved coverage 318).

In some examples, the coverage determiner 220 may utilize the analysis of the quality of coverage of a geographic region generated by the quality analyzer 216 to determine that certain households within a geographic region are receiving underserved coverage 316. For example, data associated with the customer facing maps 302 may be used to analyze the quality of coverage for a geographic region, which may reveal that a geographic region is receiving the underserved coverage 316, enabling the coverage determiner 220 to map the specific geographic region that is receiving the underserved coverage 316 to a number of households within the geographic region. Accordingly, the coverage determiner 220 may determine the households within a geographic region that are receiving the underserved coverage 316.

In some embodiments, the coverage determiner 220 may determine households within a geographic region that are experiencing the sporadic coverage 320. In some examples, the sporadic coverage 320 may include any ambient, ground, atmosphere, terrain, and/or lack of terrain that affects the quality of coverage 314. In some aspects, to determine whether something is sporadic coverage 320, the coverage determiner 220 assess whether the quality analyzer 216 determined that the radio frequency (RF) in a specific geographic region is sporadic. For example, if the quality analyzer 216 determines that the RF is present at one moment in a geographic region but disappears during the next moment, which in some cases can occur due to over propagation and/or lack of stability, then the coverage determiner 220 may determine that the households located in that specific geographic region are experiencing the sporadic coverage 320. In some embodiments, metrics that are used to determine whether there is sporadic coverage 320 may include, but are not limited to, signal strength (e.g., reference signal received power (RSRP)); signal-to-interference-plus-noise ratio (SINR) (e.g., also known as signal-to-noise-plus-interference ratio (SNIR)), which is a quantity used to give theoretical upper bounds on channel capacity (or the rate of information transfer) in wireless telecommunication systems; and drop rate (e.g., every time the signal is connected then bounces, causing an immediate drop, then the signal reconnects). In in some examples, SINR may be used to determine the quality of a signal, whether the signal is polluted with other interference, and/or whether a signal is present (e.g., all of which are indicators that the quality of coverage 314 is sporadic coverage 320).

In some examples, regarding the presence of a signal, there are two types of configurations that may happen. For example, the first type of configuration may show that the signal is ready, and if there is a UE present, the UE may connect to a base station (e.g., such as base station 202), which may establish a radio resource control (RRC) connection. In another example, if there is a fail in the RRC connection (e.g., the second type of configuration), this is an indicator that the signal is not strong enough to hold the UE, which means that the quality of coverage 314 is likely to be considered sporadic coverage 320. In some aspects, despite the sporadic coverage 320, the coverage determiner 220 may still map the geographic area that is associated with the sporadic coverage 320 to households within a specific geographic region. In some embodiments, the coverage determiner 220 may determine the quality of coverage 314 for a specific geographic region as well as the quality of coverage 314 for any neighboring geographic region.

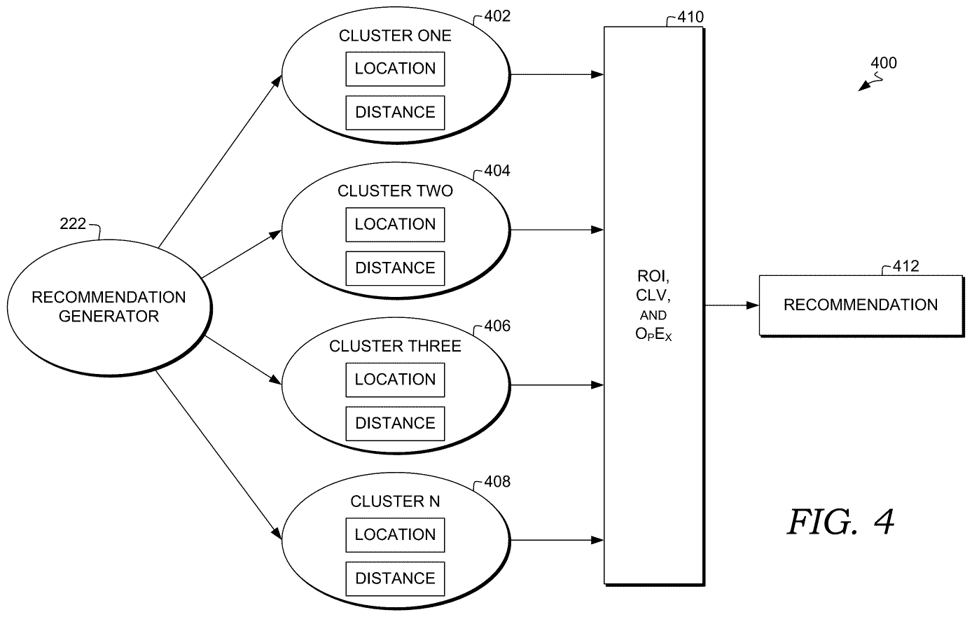

With reference now to FIG. 4, an example of a generated recommendation 300 is provided. The generated recommendation visually illustrates the recommendation generator 222 of the coverage recommendation engine 214 generating a recommendation to increase the quality of coverage for households within a geographic region. In some aspects, the recommendation generator 222 receives the quality of coverage 314 from the coverage determiner 220 (e.g., not pictured in FIG. 4). As can be seen in the example illustrated in FIG. 4, the recommendation generator 222 utilizes clustering (e.g., a cluster one 402, a cluster two 404, a cluster three 406, until a cluster N 408) and a filter 410 (e.g., filtering by ROI, CLV, and OpEx) to generate a recommendation 412 (e.g., a recommendation to increase the quality of coverage of a geographic region. As such, in some embodiments, the recommendation generator 222 may filter through coverage options that would increase the quality of coverage for households within a geographic coverage region based on the ROI, CLV, and OpEx associated with each coverage option, and the recommendation generator 222 may recommend a coverage option to increase the quality of coverage while optimizing the ROI and CLV in relation to the OpEx associated with implementing the coverage option.

In some embodiments, the recommendation generator 222 may receive the quality of coverage 314 for households within a specific geographic region from the coverage determiner 220, and the recommendation generator 222 may determine a solution to efficiently and effectively increase the quality of coverage 314 (e.g., the recommendation 412) for the households within the specific region. In some embodiments, the recommendation generator 222 may determine a solution that exceeds a predetermined threshold (e.g., associated with an increased quality of coverage) for the number of households located within a portion of a geographic region. In order to determine a solution to efficiently and effectively increase the quality of coverage 314 to best serve the underserved households located within a specific geographic region, the recommendation generator 222 may cluster the households within the geographic region into a centroid by utilizing a K-means clustering algorithm. In other words, the recommendation generator 222 may perform K-means clustering on the households within a specific geographic region. Based on the anticipated ROI and CLV in relation to the OpEx for increasing coverage for the underserved households in each centroid, the recommendation generator 222 may recommend the most efficient approach (e.g., solution) to increasing coverage, whether the approach is to build a new cell site or provide alternative means of coverage (e.g., installing a high power millimeter wave repeater, utilizing one or more satellites, utilizing a wireless backhaul with a standalone powered repeater, etc.).

In some examples, utilizing the K-means clustering algorithm, the recommendation generator 222 may group the households into certain geographic coverage areas and rank the groups (e.g., clusters) independently based on location and distance from a cell site, as well as on other metrics. For example, the recommendation generator 222 may rank each geographic coverage area associated with each group based on quality of coverage (e.g., underserved, unserved, or sporadic coverage). In some aspects, the recommendation generator 222 may divide the aggregated coverage determined by the coverage determiner 220 into clusters based on location data (e.g., geographic location). In some embodiments, each of the clusters may be grouped independently of each other. For example, a metropolitan area may be clustered into four different regions (e.g., K1, K2, K3, and K4), each aligning with discrete towns within the metropolitan area (e.g., specific geographic regions). In some examples, the size of the clusters (e.g., such as 50 users) and the distance between clusters (e.g., such as 5 miles) may be configurable by a user. In some aspects, the size and distance between clusters may depend on whether the geographic region is an urban or rural area. In some examples, a lookup table may be used by the recommendation generator 222 to generate clusters via the K-means clustering algorithm. For example, certain parameters might be entered into a lookup table that contain predefined threshold values for the size of a cluster and the distance between clusters, including minimum values to create the cluster and maximum values to define the cluster. In some examples, the recommendation generator 222 may utilize supervised learning to assign different values as it forms the clusters. With respect to the clusters, the recommendation generator 222 may determine the location of each cluster (e.g., the cluster one 402, the cluster two 404, the cluster three 406, until the cluster N 408) and the average distance of each cluster from all of the cell sites that are present in the metropolitan area (e.g., including all of the cell sites from different competitors).

For example, the recommendation generator 222 may determine that there is one cell site located 5 miles away from the cluster one 402, yet there are two other cell sites that are located less than 5 miles away from the cluster one 402. In this example, a wireless telecommunication carrier may nonetheless not use any of these three cell sites for serving the cluster one 402, because the cluster one 402 may have been determined to be a mobile dead zone (e.g., the specific geographic region experiences unserved coverage, as determined by the coverage determiner 220). In some examples, the recommendation 412 generated by the recommendation generator 222 may include a proposal to build a new cell site to serve the households within the geographic area represented by the cluster one 402. In other examples, the recommendation 412 generated by the recommendation generator 222 may include a proposal to utilize alternative means of coverage (e.g., intermediary solutions that will have a lower OpEx and still provide suitable coverage for the region) to serve the households within the geographic area represented by the cluster one 402. For example, one or more of the three cell sites in this example could serve the cluster one 402 provided the adoption of any optimizations and/or upgrades, such as a high power millimeter wave repeater. In some examples, based on the determinations made by the coverage determiner 220, the recommendation generator 222 may determine that the location associated with the cluster one 402 is where a telecommunications carrier can deploy a repeater on one of the two closer-by cell sites to enable better service to the cluster one 402. As such, the recommendation 412 may include a proposal to utilize a wireless backhaul to extend coverage out with a standalone powered repeater. In some embodiments, the recommendation 412 generated by the recommendation generator 222 may include a proposal to utilize a satellite 402 (e.g., Starlink satellites coverage, for example) to increase the coverage of the cluster one 402. In general, the recommendation 412 that is generated by the recommendation generator 222 may depend on the needs of the households located within the specific geographic region represented by the cluster one 402, as well as the ROI, CLV, and/or OpEx of implementing the recommendation 412.

In some examples, the ROI, CLV, and/or OpEx may be considered thresholds for the recommendation generator 222 in generating the recommendation 412. As such, the filter 410 (e.g., containing the expected ROI, CLV, and OpEx for each potential recommendation, such as to build a new cell site or utilize alternative means of increasing coverage) is applied to each cluster to determine how best to increase the coverage for cluster (e.g., if increasing the coverage for the cluster is recommended). For example, if the ROI and CLV for a high powered millimeter wave repeater is greater than ROI and CLV for building a macrocell, the recommendation generator 222 may recommend the alternative means of increasing coverage (e.g., the high powered millimeter wave repeater). In other words, if the ROI and CLV—in relation to the OpEx—does not meet the threshold for building a new cell site (e.g., a macrocell, in some examples), then the recommendation generator 222 may generate the recommendation 412 to include alternative means of increasing coverage. However, if the ROI and CLV—in relation to the OpEx—does meet the threshold for building a new cell site, then recommendation generator 222 may generate the recommendation 412 to include building a new cell site instead of utilizing alternative means of increasing coverage.

In some examples, the recommendation generator 222 may generate the recommendation 412 that includes using a base station to transmit a set of downlink signals using a set of transmission characteristics to the geographic coverage region, and the KPIs of this set of downlink signals (e.g., a second set of downlink signals) exceeds the previous downlink signals transmitted by the base station before the recommendation 412 was generated (e.g., exceeds the KPIs associated with a first set of downlink signals). For example, transmitting the set of downlink signals using the set of transmission characteristics may include increasing frequency and/or decreasing frequency.

In some embodiments, because, states and territories must submit their proposed plans to NTIA for approval to receive BEAD Program funds, the plans of increasing coverage determined by different states and markets may be utilized to determine the threshold ROI and CLV values. For example, if there is a state that, under the BEAD program, is requesting the creation of 200 new cell sites and that state is capable of showing that those proposed 200 new cell sites will serve around 50,000 people, then those 200 sites will have high likely of approval because the proposed solution may increase covering for a large amount of people. In this example, the costs for constructing and maintaining the 200 new cell sites (e.g., the OpEx) is subtracted from the anticipated financial gains from increasing the coverage for the 50,000 users, which determines the threshold ROI and CLV values for building 200 new cell sites for 50,0000 users, and these threshold ROI and CLV values may be stored in a database and used by the recommendation generator 222 to generate the recommendation 412 for other states (e.g., for any other specific geographic region).

In some aspects, every new cell site or alternative means of increasing coverage that is employed (e.g., recommended by the recommendation generator 222 and approved by a user with authority to approve the construction of a new cell site or utilize an intermediate solution) may have a CLV that can be utilized to measure an ROI. In some examples, the CLV may be a dollar amount that may represent what the ROI in a certain amount of time (e.g., such as a five year returns, for example) would look like. As such, in some embodiments, the CLV may be a dollar amount related to potential solutions to increase coverage for specific geographic regions, and this dollar amount may be available for every wireless telecommunications carrier. For example, if there are 50 users in a location with 10 households (e.g., 5 users per household), the recommendation generator 222 may use this metric to determine that the CLV of a certain solution (e.g., such as building a new cell site or utilizing an intermediate solution) may be a good investment for a certain wireless telecommunications carrier to increase the coverage of those 50 users in that specific geographic coverage area due to the expected ROI. As such, in this example, the recommendation generator 222 may determine which cell site (e.g., if a cell site exists) is closest to the location of the 50 users (e.g., the cluster containing the 50 users) and may notify the wireless telecommunications carrier that owns the cell site so that the wireless telecommunications carrier may increase the coverage for the 50 users.

In another example, if a first telecommunications carrier owns a cell site that is far away from the cluster two 404, then the recommendation generator 222 may generate the recommendation 412 that includes the first telecommunications carrier adding (e.g., constructing) a new cell site at or near the cluster two 404 location so that the first telecommunications carrier may not create any interference with other telecommunication carrier located at or near the cluster two 404. In this example, the other telecommunication carriers may be located closer to the location of the cluster two 404, so these other telecommunication carriers should not build another cell site at that location to maintain inter site distance. In general, the goal of the BEAD program is not to help a particular carrier, but rather the entire market by increasing coverage for users.

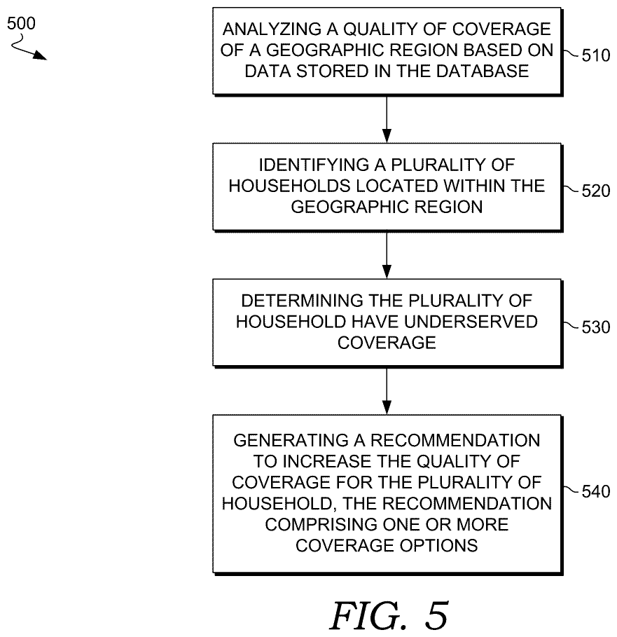

Turning now to FIG. 5, a flow chart representing a method 500 is provided. Generally the method 500 may be used by a base station, such as the base station 202 of FIG. 2, to generate recommendations to improve wireless network coverage within a geographic region. At a first step 510, the base station analyzes a quality of coverage of a geographic region based on data stored in the database, according to any one or more aspects described with respect to FIGS. 2-3. At a second step 520, the base station identifies a plurality of households located within the geographic region, according to any one or more aspects described with respect to FIGS. 2-3. At a third step 530, the base station determines the plurality of households have underserved coverage, according to any one or more aspects described with respect to FIGS. 2-3. At a fourth step 540, the base station generates a recommendation to increase the quality of coverage for the plurality of households, the recommendation comprising one or more coverage options, according to any one or more aspects described with respect to FIGS. 2 and 4.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for managing the transmission of wireless signals in a wireless telecommunication network, the method comprising:
transmitting a first set of downlink signals using a first set of transmission characteristics to a geographic region;
receiving, from each of a plurality of UEs communicatively coupled to a base station, a measurement report, each measurement report comprising one or more key performance indicators (KPIs) of the first set of downlink signals;
aggregating the measurement reports to determine a portion of the geographic area having the one or more KPIs worse than a first predetermined threshold;
determining a solution for a number of households located within the portion of the geographic region to exceed a second predetermined threshold; and
transmitting a second set of downlink signals based on the solution using a second set of transmission characteristics to the geographic region, wherein the one or more KPIs of the second set of downlink signals exceeds the first predetermined threshold in the portion of the geographic area.

2. The method of claim 1, wherein the KPIs include signal strength, bandwidth, latency, connectivity, interference, and drop rate.

3. The method of claim 1, wherein a generative artificial intelligence (AI) aggregates the measurement reports to determine the portion of the geographic area having the one or more KPIs worse than the first predetermined threshold and determines the solution for the number of households located within the portion of the geographic region to exceed the second predetermined threshold.

4. The method of claim 1, wherein transmitting the second set of downlink signals using the second set of transmission characteristics comprises increasing frequency.

5. The method of claim 1, wherein transmitting the second set of downlink signals using the second set of transmission characteristics comprises decreasing frequency.

6. A system for generating recommendations to improve wireless network coverage within a geographic region, the system comprising:
one or more computer processing components; and
a non-transitory computer readable media having instructions stored thereon that, when executed by the one or more computer processing components, cause the one or more computer processing components to perform operations comprising:
analyzing a quality of coverage of a geographic region based on aggregated data of relative service weakness stored in a database;
identifying a plurality of households located within a geographic region;
determining the plurality of households have underserved coverage; and
generating a recommendation to increase the quality of coverage for the plurality of households, the recommendation comprising one or more coverage options.

7. The system of claim 6, wherein the aggregated data stored in the database further comprises customer facing maps data, Federal Communications Commission (FCC) data, and crowdsourced data.

8. The system of claim 6, wherein the quality of coverage includes signal strength, bandwidth, latency, connectivity, interference, and drop rate.

9. The system of claim 6, wherein a generative artificial intelligence (AI) analyzes the quality of coverage of the geographic region, identifies the plurality of households located within the geographic region, determines the plurality of households have the underserved coverage, and generates the recommendation to increase the quality of coverage for the plurality of households.

10. The system of claim 6, wherein identifying the plurality of households further includes referencing United States Census data, wherein the United States Census data is stored in the database.

11. The system of claim 10, wherein determining the plurality of households have the underserved coverage further comprises mapping the United States Census data to crowdsourced data stored in the database.

12. The system of claim 6, wherein the underserved coverage includes the underserved coverage, unserved coverage, and sporadic coverage.

13. The system of claim 6, wherein the recommendation to increase the quality of coverage is further based on return on investment (ROI), customer lifetime value (CLV), and operational expenditure (OpEx).

14. The system of claim 6, wherein the one or more coverage options includes building a new cell site and alternative means of coverage.

15. The system of claim 14, wherein the alternative means of coverage includes installing a high power millimeter wave repeater, utilizing one or more satellites, and utilizing a wireless backhaul with a standalone powered repeater.

16. The system of claim 6, wherein generating the recommendation to increase the quality of coverage further comprises a generative AI utilizing K-means clustering, wherein the K-means clustering further comprises:
grouping the plurality of households into one or more geographic coverage areas;
determining the distance of the one or more geographic coverage areas from one or more cell sites; and
ranking the geographic coverage areas based on the quality of coverage.

17. A non-transitory computer readable media having instructions stored thereon that, when executed by one or more computer processing components, cause the one or more computer processing components to perform a method for generating recommendations to improve wireless network coverage within a geographic region, the method comprising:
analyzing a quality of coverage of a geographic region based on aggregated data of relative service weakness stored in a database;
identifying a plurality of households located within the geographic region;
determining the plurality of households have underserved coverage; and
generating a recommendation to increase the quality of coverage for the plurality of households, the recommendation comprising one or more coverage options.

18. The non-transitory computer readable media of claim 17, wherein the quality of coverage includes signal strength, bandwidth, latency, connectivity, interference, and drop rate.

19. The non-transitory computer readable media of claim 17, wherein a generative artificial intelligence (AI) analyzes the quality of coverage of the geographic region, identifies the plurality of households located within the geographic region, determines the plurality of households have the underserved coverage, and generates the recommendation to increase the quality of coverage for the plurality of households.

20. The non-transitory computer readable media of claim 17, wherein the one or more coverage options includes building a new cell site, installing a high power millimeter wave repeater, utilizing one or more satellites, and utilizing a wireless backhaul with a standalone powered repeater.
